(19) United States
(12) Patent Application Publication
(10) Pub. No.: US 2026/0050409 A1
(43) Pub. Date: Feb. 19, 2026

(54) DISPLAY MANAGEMENT USING VOICE CONTROL

(71) Applicant: GOOGLE LLC, Mountain View, CA (US)

(72) Inventors: Nishtha Bhatia, Fremont, CA (US); Karolina Richterova, Brooklyn, NY (US); Richard William Worsfold, Kirkland, WA (US); David Allin Reese, San Francisco, CA (US); Joost Korngold, Morgan Hill, CA (US); Katherine Faith Erdman, Mountain View, CA (US); Maxwell Spear, San Francisco, CA (US); Juston Payne, Woodside, CA (US); Diego Rivas Vetencourt, San Francisco, CA (US); Dongeek Shin, San Jose, CA (US); Tuan Anh Nguyen, San Jose, CA (US)

(21) Appl. No.: 19/301,264

(22) Filed: Aug. 15, 2025

Related U.S. Application Data
(60) Provisional application No. 63/683,543, filed on Aug. 15, 2024.
(60) Provisional application No. 63/808,430, filed on May 19, 2025.

(51) Int. Cl. G06F 3/16; G06F 3/0484

(52) U.S. Cl. CPC G06F 3/167; G06F 3/0484

(57) ABSTRACT

According to at least one implementation, a method includes receiving voice input from a user of a device and determining that the voice input satisfies at least one criterion associated with a first configuration of virtual objects on a display of the device. The method further includes changing the first configuration of the virtual objects to a second configuration of the virtual objects in response to the voice input satisfying the at least one criterion.

### CROSS-REFERENCE TO RELATED APPLICATION

This application claims the benefit of U.S. Provisional Application No. 63/808,430, filed May 19, 2025, and U.S. Provisional Application No. 63/683,543, filed Aug. 15, 2024, the disclosures of which are incorporated herein by reference in their entireties.

### BACKGROUND

A wearable device, such as an extended reality (XR) device or smart glasses, is a computing system that enables a user to perceive and interact with digital content within a physical environment by combining elements of virtual reality (VR), augmented reality (AR), and/or mixed reality (MR). To display content, the XR device uses a combination of sensors (e.g., cameras, inertial measurement units, eye trackers) to determine the user's pose, position, and surrounding context. The device can be configured to render 2D or 3D virtual imagery that is spatially aligned with the real world. The content can then be provided or projected onto transparent or opaque displays within the device's optical system, enabling immersive or contextually overlaid visuals.

### SUMMARY

This disclosure relates to systems and methods for managing the display of content on a device using voice control. In at least one implementation, a wearable device, such as an XR device, can receive voice input from a user of the device. The device can further determine that the voice input satisfies at least one criterion associated with a first configuration of virtual objects on a display of the device. Based on the voice input satisfying the at least one criterion, the system can be configured to change the first configuration of the virtual objects to a second configuration of the virtual objects.

In some implementations, the change from the first configuration to the second configuration includes moving one or more of the virtual objects from a first location to a second location. In some implementations, the change from the first configuration to the second configuration includes changing the size of one or more virtual objects from a first size to a second size. In some examples, the change from the first configuration can involve a combination of changes in size, location, or other display characteristics.

In some aspects, the techniques described herein relate to a method including: receiving voice input from a user of a device; determining that the voice input satisfies at least one criterion associated with a first configuration of virtual objects on a display of the device; and in response to the voice input satisfying the at least one criterion, changing the first configuration of the virtual objects to a second configuration of the virtual objects.

In some aspects, the techniques described herein relate to a system including: a computer-readable storage medium; at least one processor operatively coupled to the computer-readable storage medium; and program instructions stored on the computer-readable storage medium that, when executed by the at least one processor, direct the system to perform a method, the method including: receiving voice input from a user of a device; determining that the voice input satisfies at least one criterion associated with a first configuration of virtual objects on a display of the device; and in response to the voice input satisfying the at least one criterion, changing the first configuration of the virtual objects to a second configuration of the virtual objects.

In some aspects, the techniques described herein relate to a computer-readable storage medium storing executable instructions that, when executed by at least one processor, cause the at least one processor to execute a method, the method including: receiving voice input from a user of a device; determining that the voice input satisfies at least one criterion associated with a first configuration of virtual objects on a display of the device; and in response to the voice input satisfying the at least one criterion, changing the first configuration of the virtual objects to a second configuration of the virtual objects.

The accompanying drawings and the description below outline the details of one or more implementations. Other features will be apparent from the description, drawings, and claims.

### BRIEF DESCRIPTION OF THE DRAWINGS

FIG. 1A illustrates a computing environment 100 to manage the display of applications according to an implementation.

FIG. 1B illustrates an updated display view based on user input according to an implementation.

FIG. 2 illustrates a method of managing a display of applications on a device according to an implementation.

FIG. 3 illustrates an operational scenario of rearranging applications on a display based on voice input according to an implementation.

FIG. 4 illustrates an operational scenario of updating a display configuration for applications according to an implementation.

FIG. 5 illustrates an operational scenario of updating a display configuration for applications according to an implementation.

FIG. 6 illustrates a block diagram of a device according to an implementation.

FIG. 7 illustrates a first example implementation of a spatial action model.

FIG. 8A is a block diagram illustrating a second example implementation of a spatial action model.

FIG. 8B is an example semantic graph that may be used in the implementation of FIG. 8A.

FIG. 8C illustrates a first example of page sparsification that may be used in the implementation of FIG. 8A.

FIG. 8D illustrates a second example of page sparsification that may be used in the implementation of FIG. 8A.

FIG. 9A is a block diagram illustrating a third example implementation of a spatial action model.

FIG. 9B is a block diagram illustrating a fourth example implementation of a spatial action model.

FIG. 10 is a block diagram illustrating a fifth example implementation of a spatial action model.

FIG. 11 is a block diagram illustrating a sixth example implementation of a spatial action model.

FIG. 12 illustrates a computing system to provide an updated display configuration according to an implementation.

### DETAILED DESCRIPTION

A wearable device, such as an extended reality (XR) device, can display application windows by generating virtual representations of those windows within a three-dimensional digital environment. These windows may originate from traditional two-dimensional applications (e.g., productivity software, web browsers, etc.) or native XR applications (e.g., immersive games, modeling, etc.). The XR device renders each application window as a visual layer or panel that appears to float in space within the user's field of view. The rendering of the application windows can be accomplished using stereoscopic displays and spatial tracking technologies that allow the windows to remain anchored in a specific position relative to the user's viewpoint or physical environment.

To provide intuitive interaction for a user, the wearable device can identify head and/or hand movements associated with the user, allowing the device to reposition, resize, or manipulate application windows using gestures, gaze, or input devices such as controllers. The windows can be fixed in world space (i.e., anchored to a location in the real or virtual environment) or follow the user (anchored to the display or a dynamic frame of reference). The device can be configured to manage depth perception, occlusion, and layering to present the application windows in a realistic and accessible manner, allowing multiple applications to be used concurrently. However, as numerous windows are added to the user's display, the user can encounter at least one technical problem in managing the different application windows on the device.

In at least one technical solution, the device can be configured to identify voice input from the user and manage the application windows displayed by the device based on the voice input. In at least one implementation, the user can open a set of application windows that the device can display. In some examples, the device can display multiple application windows by rendering each as a separate virtual panel in the 3D environment. These windows can be positioned side by side, stacked, or placed around the user in space. In some implementations, the device enables users to move windows using gestures or controllers. For example, the user can provide a gesture that selects a window using a pinching gesture and moves the window alongside a second window by moving the hand.

In addition to identifying gesture inputs or inputs via a controller, the wearable device can further monitor voice input from a user. The device can be configured to receive voice input using microphones and voice recognition software that capture and process spoken commands. As used herein, “voice input” refers to an audio signal captured by a microphone that contains a user's spoken utterance. The voice input is processed by the device, either by converting the audio signal to text for natural language processing or by analyzing the audio features of the signal directly, to determine a user's intent or command. In some examples, the device utilizes natural language processing to interpret speech and trigger corresponding actions within the virtual environment. For example, the user can provide input, such as “Clean up” or “Tidy up.” The device can identify both the voice input and the intent associated with the input (e.g., recognizing an intent to rearrange the position and/or size of application windows). From the intent satisfying at least one criterion, the device can initiate an action to position the windows in more visually pleasing positions associated with the user's perspective. As used herein, at least one criterion can refer to a condition that is satisfied when a natural language processing system analyzes voice input and determines that the input corresponds to a user's intent to manage a display configuration. The criterion is met upon the successful identification of an actionable command to rearrange, organize, or otherwise modify the layout (i.e., configuration) of one or more application windows or other displayed virtual objects. As used herein, the term configuration can refer to the spatial arrangement, layout, or organization of one or more virtual objects on a display (e.g., application windows). For example, a configuration can define the positions, sizes, orientations, and layering of application windows in a user's field of view. A configuration can also refer to a set of parameters or properties that define the appearance and behavior of virtual objects, such as their visibility, transparency, or interactivity settings. A configuration change can modify the display of a single virtual object (e.g., a selected object) or can include multiple virtual objects.

In some implementations, the positioning of the windows includes moving the windows so that the content of the windows no longer overlaps (windows are no longer overlaid). In some implementations, the position of the windows includes resizing the windows to use a greater portion of the field of view. In some implementations, the positioning of the windows consists of a combination of moving and resizing the windows. In some examples, the positioning of the windows includes placing each application into a spot in a grid or linear arrangement (also referred to as a configuration). As at least one technical effect, each application can be separated and distinguished for the user in the new arrangement. In some implementations, the movement of the windows can be relative to a point in physical space.

In some implementations, natural language processing enables the wearable device to respond to voice input. When a user speaks, the device captures the audio through at least one microphone and converts the speech into text. The system then breaks down the text into smaller parts, such as words and phrases, to determine what the user is trying to say. The device can implement one or more machine learning models or rules to analyze the meaning and intent of the input. Based on the determined intent, the device performs the appropriate action (i.e., displaying a more organized version of the content, moving windows in space, or attaching windows to specific locations in real space). In some implementations, some models can process the audio without converting the speech to text. Instead, the model can process the audio input directly, analyzing the frequencies and audio features of the audio itself. As a result, the system can process the voice input by converting it to text and determining intent or processing the audio signal itself to determine intent.

In some implementations, the system can be configured to identify additional context associated with organizing the application windows for the display. In some examples, the additional context can include the user's gaze. The wearable device can be configured to determine the gaze using eye movement cameras or sensors built into glasses or a headset. These sensors detect the position and movement of the eyes (e.g., using infrared light to track reflections from the cornea). The device can determine the gaze direction by calculating where the user is looking on a screen or in the environment. For example, the user can provide voice input of “Focus on this application.” The device can be configured to determine the intent associated with the voice input (i.e., organizing the application windows) and to determine an arrangement or configuration for the windows based on the application context. For example, the device can be configured to display the referenced application, determined through the user's gaze, in a centered location. The remaining application windows can be shown around the focused application, minimized or removed from the display, or provided in some other manner that prioritizes the referenced application. In some examples, the other applications can be positioned around the focused application in a grid or linear arrangement (i.e., limiting overlap or occlusion for the applications). In some implementations, the device can use gestures to determine the context associated with the voice input. For example, the user can provide a pointing gesture that indicates an application to be focused or arranged by the device.

In some implementations, the device can maintain a memory or data store that manages preferences associated with different applications and windows. For example, the data store can indicate an arrangement (i.e., configuration) or layout for different applications in relation to one another. In at least one implementation, the user can provide voice input to arrange the applications displayed by the device. In response to the request, the device can determine the displayed applications and arrange them based on the data store preferences for those applications. The preferences can indicate which applications to center or promote over other applications, display locations for the applications relative to one another, or provide other information associated with the applications. These preferences can also be tailored based on the type of experience (e.g., watching media). For example, the device can determine that a first application and a second application are displayed. In response to voice input for “Clean up,” the device can identify the intent, and display the applications based on preferences associated with the applications (e.g., display the first application in a first space on the left side of the user point of view and the second application in a space on the right side of the user point of view).

In some implementations, the user provides the preferences associated with the applications. For example, the user can indicate preferred display locations associated with the applications (or a set of applications). When the user provides voice input associated with rearranging or cleaning up the display, the device can access the preferences and adjust the display of the applications. In some implementations, the device can infer the preferred locations associated with different application windows. For example, the device can identify frequent positions related to the various applications and predict a location for the application when the user requests rearrangement. Thus, if the first application is frequently positioned to the left of a second application, the device can be configured to arrange the applications based on the frequency with which the applications are positioned relative to one another.

In some implementations, the applications on the device can be configured with settings for displaying the applications. In some examples, the settings can correspond to the arrangement of the application relative to one or more other applications. For instance, an application can be associated with a command to arrange the application relative to one or more related applications. When the user provides a verbal command, the system can arrange the windows according to the arrangement setting for the application. For example, the verbal command can be used to center the first application while positioning one or more other applications around the first application. In some implementations, the system can identify the user's gaze and determine the application accordingly. Based on the position of the user's gaze, a first application can be selected, and the applications can be displayed based on settings associated with the first application. For example, the first application can be placed on one side of the display, while the other applications are placed on the other side of the display.

In some implementations, the system can identify one or more applications (or application types) displayed as part of a first configuration. For example, three application windows can be displayed for the user. In response to a request from the user (e.g., a voice request), the system can determine a second configuration based on an application of a model configured to provide the second configuration based on the one or more applications. In some implementations, the model can be configured or trained based on previous application layouts or configurations by the current user. In some implementations, the model can be configured or trained based on application layouts associated with multiple persons. For example, the model can be configured using a test data set associated with user layouts for various applications and application types. The term application types (or types of applications) can be categorized by function, such as productivity applications (e.g., word processors, calendars), games, media players, communication tools, and utilities (e.g., file managers, calculators). For example, the device can position a gaming application in a different manner than a productivity application.

In some examples, the model can be trained to configure application windows for a user by processing historical usage patterns (from the user or additional users), screen configurations, and user preferences. The model can receive input features, such as the type of applications on the screen, time of day, current window sizes for applications, recent activity in the applications, user interactions (e.g., dragging, resizing, or minimizing windows), or other state information associated with the applications and the device. During the configuration or training process, the model observes labeled examples of desired window arrangements (e.g., either from user actions or curated data) and uses supervised or reinforcement learning to predict the desired configuration or layout for other applications. In some examples, the device can further use features associated with the user request, such as explicit information in the voice request (put this application in the center), gestures toward an application (e.g., promote a particular application), or the user's gaze focusing on a particular application. In some implementations, the device can use multiple models to process the inputs from the user request and generate the desired outputs.

For example, the user can open three applications: a word processing application, an email application, and a web browser. The device can identify a request from a user to arrange the windows (e.g., “Clean up”) and can select positions and sizes for the windows based on training. In some examples, the model can be configured to receive inputs, such as the application type, the time of day, the user's gaze, or some other inputs. The inputs can then define the new configuration for the applications, relocating them to potentially desirable locations.

Although the previous examples describe updating the display arrangement for applications based on user speech, alternative events can cause a change to the arrangement. For instance, if the user executes a new application, the arrangement can be updated to include the new application. In some implementations, the update can be based on the identifier or type of application executed, where preferences associated with the application (and other launched applications) can be used to determine the location and size of the newly executed application. For example, if a productivity application is executed, the device can update the display of one or more applications to accommodate the productivity application and position applications in an arrangement consistent with the preferences for the application.

Although demonstrated in the examples herein as rearranging applications, similar operations are performed generally in rearranging virtual objects displayed by a wearable device. In the context of this disclosure, a virtual object refers to a computer-generated element displayed within a user's field of view on a device, such as an extended reality (XR) device. A virtual object can represent various types of digital content, including, but not limited to, an application window, a graphical user interface (GUI) element (e.g., an icon, button, or menu), a two-dimensional (2D) or three-dimensional (3D) model, text, or an image. These virtual objects can be interactive and manipulated by a user through various inputs, such as voice commands, gestures, or gaze. For example, a virtual object can be an application window that a user can move, resize, or rearrange in a virtual space.

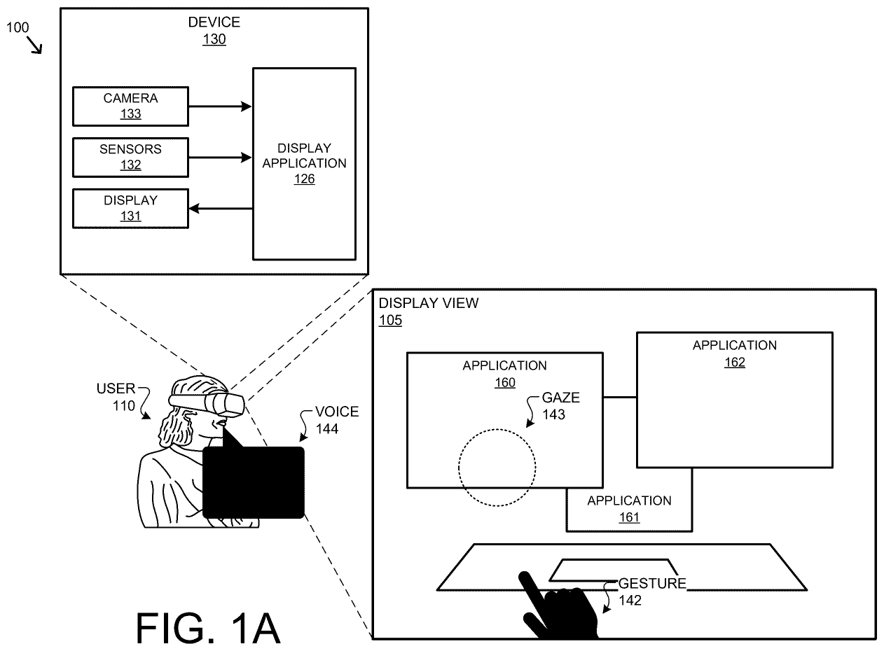

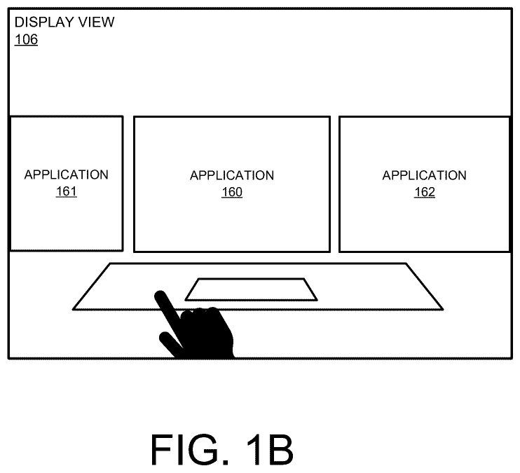

FIG. 1A illustrates a computing environment 100 to manage the display of applications according to an implementation. Computing environment 100 includes user 110, device 130, voice 144, and display view 105. Device 130 includes display 131, sensors 132, camera 133, and display application 126. Display view 105 represents the view of user 110 using device 130. Display view 105 includes gesture 142, gaze 143, and applications 160, 161, and 162. Device 130 is an example of a wearable device, such as an XR device, smart glasses, or another wearable device.

In at least one implementation, device 130 displays content associated with display view 105. Device 130 identifies voice 144 corresponding to a request to rearrange the content on the display and updates the display to provide display view 106 depicted in FIG. 1B. In some implementations, the rearranging can be used to limit the overlapping of applications by moving and/or changing the size of the application windows for applications 160, 161, and 162. In some implementations, the rearranging can be used to distribute the various applications on the display. As at least one technical effect, the rearranging permits user 110 to identify executing applications and content on display 131 more effectively. Although not depicted in computing environment 100, at least some display operations described herein can be implemented using a companion device (e.g., smartphone, tablet, etc.), computing system, or another device communicatively coupled to device 130. For example, while device 130 can display the content, a second device can render the content and communicate the content to device 130.

In computing environment 100, device 130 includes display 131, which is a screen or projection surface that presents immersive visual content to user 110, merging virtual elements with the real world. Display 131 can include optical see-through displays (e.g., AR headsets) or video pass-through (e.g., MR/VR devices). Device 130 further includes sensors 132, such as accelerometers, gyroscopes, magnetometers, depth, infrared, and proximity sensors. The sensors can be used to monitor the physical movement of the user, identify depth information for other objects, identify eye movement for the user, or perform other operations. Device 130 also includes camera 133, which can capture the real or physical environment to overlay virtual objects (e.g., application interfaces) for identifying movements of user 110 and surroundings to enable accurate interaction within the augmented or virtual space. In some examples, camera 133 can be positioned as an outward view to capture the physical world associated with the user's gaze. Display 131 can receive updates from display application 126 to display content associated with applications 160, 161, and 162. Sensors 132 and camera 133 provide data to display application 126 that can identify the gaze or gestures from the user. The data can provide context associated with the voice 144.

In some technical solutions, display application 126 identifies voice 144, wherein voice 144 can correspond to a request to change the arrangement of applications 160, 161, and 162 in display view 105. For example, the user can provide, “Clean this up.” Display application 126 can receive the voice input and determine that the voice input corresponds to an intent to rearrange the applications on the display. In some examples, display application 126 can use natural language processing to identify express terms for rearranging the display of applications 160, 161, and 162. In some examples, natural language processing can use machine learning model to identify the intent of the user, where the model can identify variations in phrasing and terminology associated with the speech. For example, the user can use different words or phrases to declutter or improve the presentation of the application windows on the device. The machine learning model can be configured (i.e., trained) using examples of user speech transcripts paired with labeled intents. The examples can teach the model to identify patterns using algorithms like logistic regression, decision trees, or deep learning (e.g., neural networks). The model adjusts its internal parameters during the configuration period to minimize the error between its predicted intents and the labels, using optimization techniques like gradient descent. Once configured, the model can generalize to predict intents from new, unseen speech inputs of the user.

In some examples, prompt engineering can guide or influence how a model responds without changing the model itself. During training or fine-tuning, designed prompts can be used to teach the model specific patterns or behaviors by repeatedly showing it how to respond to specific instructions. For example, different prompts can be used to direct the system to different results or different application layouts and appearances.

In some implementations, the device can maintain a data store that associates applications with preferred positions and sizes relative to other applications executing on the device. In some examples, the data store can indicate preferred sizes and/or locations of the applications. In some examples, the data store can indicate preferred locations relative to other applications. For example, if both applications are open, the data store can indicate that a first application should be placed to the right of a second application (relative to the user). In some implementations, the preferences in the data store can be preconfigured. In some implementations, the user 110 can indicate preferences associated with the arrangement of the applications. In some implementations, the preferences can be inferred based on the frequency with which the applications are placed in specific locations. For example, when the user provides voice 144 to rearrange applications 160, 161, and 162, display application 126 can determine the locations and sizes for the applications based on the preferences in the data store (e.g., location, size, etc.).

In some examples, the system can use context associated with the request to rearrange applications 160, 161, and 162 in addition to or in place of the preferences in the data store. For example, the display application 126 can use gaze 143 or gesture 142 to determine an application window that is the focus of user 110. In response to voice 144 (e.g., “Clean up” statement), display application 126 can identify gaze 143 and/or gesture 142 to determine a focused window for user 110. The device can then rearrange the applications 160, 161, and 162, prioritizing the focused window for the user. The location and size of the other windows can be determined based on the focused window and preferences associated with the focused window. In some implementations, the location and size can be based on the preferences stored on a data store (e.g., preferences that application 161 be placed to the left of application 160).

Turning to FIG. 1B, FIG. 1B includes display view 106 as an example of rearranging applications on display 131 of device 130. When user 110 provides voice input indicating an intent to change the arrangement of the applications on display 131, display application 126 determines a new arrangement for applications 160, 161, and 162. The arrangement can be based on preferences in data store for applications 160, 161, and 162, can be based on gestures and/or gaze of the user, can be based on the current location of the windows, or can be based on some other factor, including combinations thereof. In some implementations, the arrangement or configuration can be determined using multi-model input that can include the user's voice as well as additional context (gesture, gaze, etc.). Because gaze 143 is centered on application 160, application 160 is placed in the center of display view 106 with application 161 on the left side and application 162 on the right side. Although this is one example of arranging the applications, the applications can be placed in various formats. In some implementations, the new arrangement separates any overlapping applications. This can be accomplished by moving or changing the size of one or more application windows to prevent overlap. In some examples, the applications can be placed into a grid or line, allowing the user to identify and focus on relevant windows more easily. Using the example of display view 106, the applications can be placed linearly, allowing the user to identify each open application. The location of each application can be based on the preferences for the applications, the location of each application before the request (e.g., move the applications to the nearest spot in the line), the gaze or gesture of the user, or based on some other factor.

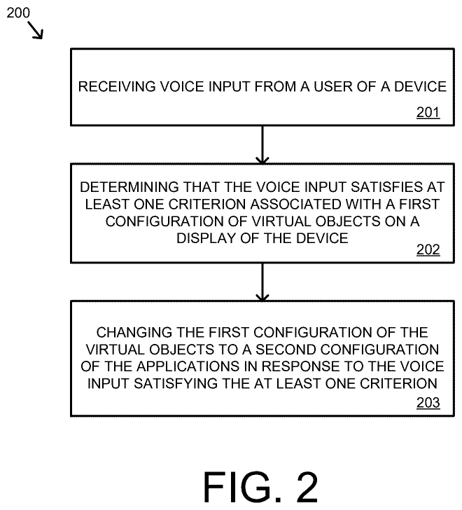

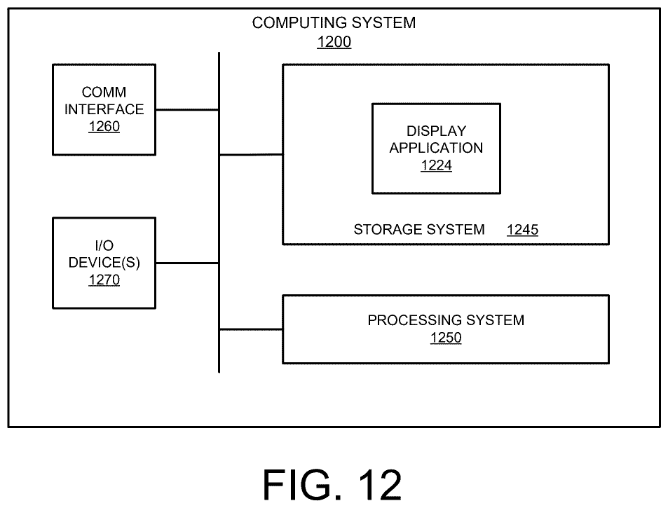

FIG. 2 illustrates method 200 of managing a display of applications on a device according to an implementation. In some examples, method 200 can be implemented by a wearable device, such as an XR device. In some examples, method 200 can be implemented by computing system 1200 of FIG. 12. Although demonstrated in the examples below as arranging and configuring applications and application windows, similar operations can be performed in association with any virtual object. A virtual object, in the context of this application, can be any digitally generated element presented to a user, such as an application window, an icon, a 3D model, or a user interface component, that can be manipulated within a virtual or augmented reality environment.

Method 200 includes receiving voice input from a user of a device at step 201. The term “voice input” denotes any spoken command or utterance from a user that is received by the device and serves as an instruction for controlling the user interface. The system processes the voice input to identify an actionable intent, such as the intent to change the configuration of displayed applications. Method 200 further comprises determining that the voice input satisfies at least one criterion associated with a first configuration of virtual objects on a display of the device at step 202. The term criterion, as used in this specification, can denote a predefined rule or logical condition against which processed voice input is evaluated. The criterion is satisfied if the processed input, including its semantic meaning or identified keywords (e.g., “clean up”), matches a rule associated with triggering a display management action. A criterion can be a threshold or condition in a decision-making process that, when met by data derived from user voice input, initiates a change in the state of a user interface. In the context of this disclosure, the criterion is satisfied when a model or rule-based system concludes from the voice input that an action to reconfigure displayed virtual objects (e.g., applications) is being requested. In some implementations, the device can be configured to perform natural language processing. Natural language processing can enable the device to interpret and act on voice input by converting spoken language into text through speech recognition, analyzing the intent and meaning using linguistic and contextual analysis, and then triggering relevant actions based on predefined rules or machine learning models. In some implementations, a device can use predefined rules that are manually created instructions that map phrases to specific actions. In some implementations, the device can use machine learning models that are configured (i.e., trained) on language data to recognize patterns and determine intent more flexibly. The machine learning models can process variations in phrasing or wording to perform a particular action. In some implementations, the device can monitor the voice input of the user and determine when the voice input corresponds to an intent to rearrange the display of applications (or other virtual objects) on the device. For example, when the user opens a set of application windows, the user may have difficulty identifying the windows or effectively moving and resizing the windows in the field of view. The device can identify speech from the user and determine when the speech corresponds to the arrangement of application windows on the device. For example, when the user provides phrases like “Clean up” or “Arrange windows,” the device can determine that at least one criterion is satisfied in association with the current arrangement.

Method 200 further includes changing the first configuration of the virtual objects to a second configuration of the virtual objects in response to the voice input satisfying the least one criterion at step 203. Changing the configuration can include resizing one or more application windows in some implementations. In some examples, changing the configuration can consist of moving one or more of the application windows. In some implementations, changing the arrangement can include a combination of resizing, moving, minimizing, or some other action associated with the applications. The term configuration, as used herein, can refer to the spatial arrangement and display properties of one or more virtual objects on a display. For example, a configuration can specify the position (e.g., coordinates), size (e.g., dimensions), orientation, and layering (e.g., z-order) of application windows or other virtual objects within a user's field of view. A configuration can also refer to a specific layout of virtual objects, such as a grid, a linear arrangement, or a user-defined arrangement, including any associated settings or preferences that dictate how the virtual objects are presented relative to each other or a user's viewpoint. The changing of the configuration can include changing a single virtual object (e.g., a focused virtual object) or can involve changing multiple virtual objects (e.g., rearranging the position, dimensions, and layering of the objects).

In some implementations, the system can arrange the applications based on the identity of the applications on the display. For example, the device can be configured to place a first application visually to the left of a second application. In response to the voice request from the user, the device can identify the application windows and rearrange the windows such that the first application is viewable to the left of the second application. In some examples, the user provides preferences (e.g., the user indicates a preferred arrangement for the application windows). In some implementations, the device can be configured to identify frequent arrangements of the user and arrange the applications based on expected arrangements for the applications. For example, suppose the user frequently places a first application to the left of a second application on the display. In that case, the device can identify the voice request, identify the applications on the display, and arrange the applications based on the user's preferred arrangement.

In some implementations, the rearrangement of the applications can be based on the user's gaze or gesture. For example, when the user requests a realignment of the windows, the device can identify the user's gaze location and determine a corresponding application for the gaze location. The device can then promote (e.g., center, make larger, etc.) the application at the focus of the user's gaze. The other applications can then be placed around the promoted application. The locations and size of the other applications can be based on the previous locations for each of the applications at the time of the request, preferences associated with each application, or some other factor. For example, when the user focuses on a text editing application and requests the windows be rearranged, the text application can be centered in the user's view. The other applications can then be positioned around the focused application. In some examples, the applications are rearranged to prevent overlapping between applications. In some examples, the applications are rearranged into a grid (or in a line). The applications can be displayed with the same size window or can be displayed with different sized application windows. In some examples, the application associated with the gaze can be displayed with a first size, while the other applications are displayed with one or more additional (e.g., smaller) sizes).

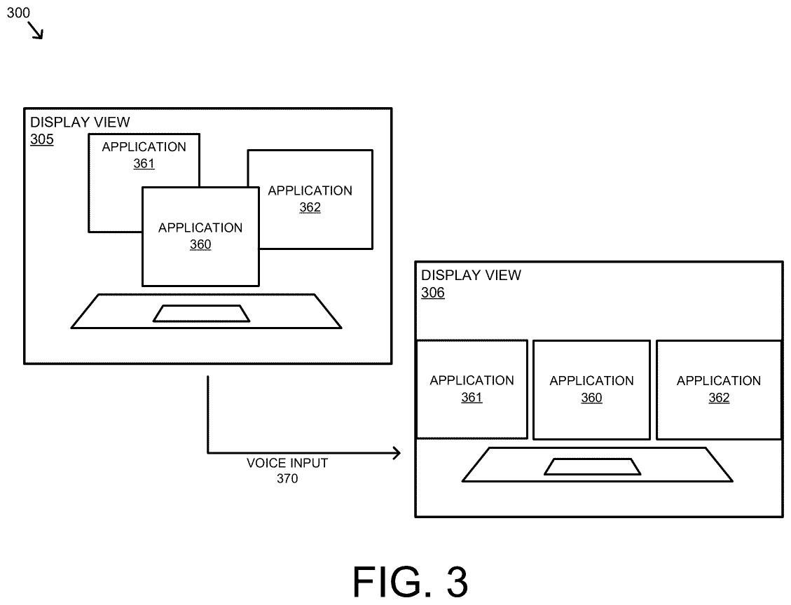

FIG. 3 illustrates an operational scenario 300 of rearranging applications on a display based on voice input according to an implementation. Operational scenario 300 includes display view 305 and display view 306 with applications 360, 361, and 362. Operational scenario 300 further includes voice input 370. Display views 305 and 306 represent a user's view from a wearable device, such as an XR device, smart glasses, and the like.

In operational scenario 300, applications 360, 361, and 362 are displayed by a wearable device to provide display view 305. Applications 360, 361, and 362 can include immersive training, virtual collaboration, 3D visualization, interactive simulations, gaming, productivity, or another application. In response to voice input 370, the device generates display view 306 that rearranges applications 360, 361, and 362. In some examples, the device can provide natural language processing to identify the intent of the user to rearrange the application content displayed. The content can be arranged in display view 306 based on preferences associated with the applications (e.g., a first application to the left of a second application), can be arranged based on proximity to grid or slot in a cleaned interface (e.g., moved to an open location in a linear display of the applications, such as display view 306), can be arranged based on the gaze or gesture of the user, or can be arranged based on some other factor, including combinations thereof.

Using the example of display view 306, applications 360, 361, and 362 are moved and/or resized to position the applications in a linear arrangement on the display. In some examples, the locations of the applications can be determined based on proximity to the available locations in the new arrangement (i.e., application 361 is closest to a first potential location, application 360 is closest to a second potential location, and application 362 is closest to a third potential location in the linear arrangement of display view 306). In some examples, the device can consider additional or alternative factors, including the application type, the gaze of the user, and/or another factor. Although demonstrated in a linear arrangement of display view 306, the applications can be placed into a grid or some other arrangement. Additionally, the device can change the size of the applications to support different functionality, such as the focus of the user on a specific application.

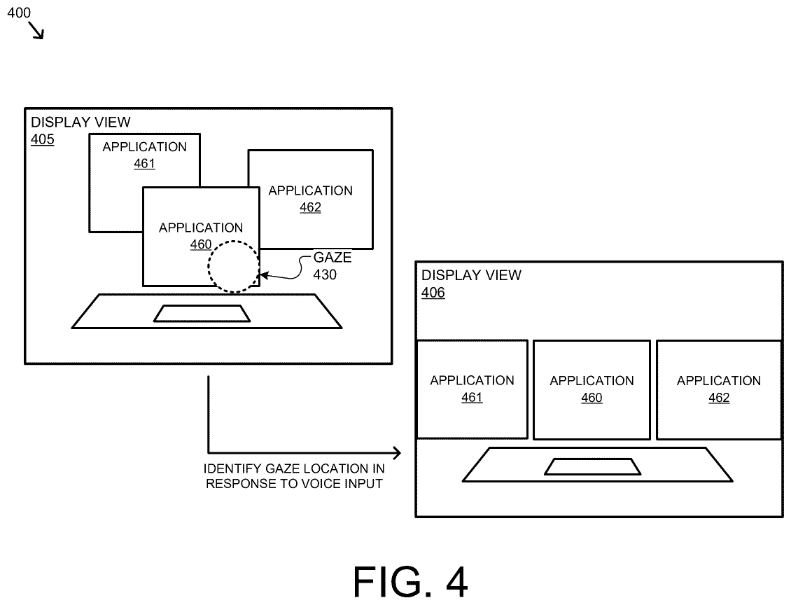

FIG. 4 illustrates an operational scenario 400 of updating a display configuration for applications according to an implementation. Operational scenario 400 includes display view 405 and display view 406 with applications 460, 461, and 462. Operational scenario 400 further includes gaze 430. Display views 405 and 406 represent a user's view from a wearable device, such as an XR device or smart glasses. Although demonstrated as separate applications, similar operations can be performed on different application windows for the same application. For example, similar operations can be performed for multiple instances of a web browsing application.

In operational scenario 400, the user is presented with display view 405, which includes a first configuration for displaying applications 460, 461, and 462. Here, in display view 405, applications 460, 461, and 462 are displayed with application 460 partially covering applications 461 and 462. In some implementations, the user can use hand gestures or controllers to move the applications on the display. As applications are opened or executed by the user, the display can become complicated or difficult to process. For example, during research for a trip, the user may open a variety of windows, including a notes application, a web browser, an email application, and the like to perform the desired research. These applications can be opened or moved such that portions of the windows are obstructed or sized inappropriately relative to the other applications.

To enhance the display presentation, the device can be configured to recognize user input and update the application configuration accordingly. In some implementations, the input comprises voice input. The voice input can include a command or request from the user associated with managing the configuration of the displayed applications. In some implementations, the device can perform natural language processing to determine the user's intent to update the configuration. The device can use natural language processing to analyze spoken (or written) input to detect intent and elements like actions and objects. For example, when a user requests to rearrange the displayed applications, the system can identify the request and translate the request into a display update.

In the example of operational scenario 400, the system can be configured to identify the user's request and determine a gaze associated with the user. The gaze can be used to infer intent or a focus for the user (e.g., the current application being used by the user). The system can determine the gaze using built-in eye cameras that determine the movement and position of the eyes. By analyzing where the eyes are focused, the system determines the user's point of attention within the environment (e.g., gaze 430 on application 460). In response to determining gaze 430, the system generates display view 406 with application 460 promoted for the user. In some implementations, based on the gaze, the corresponding application can be centered. In some implementations, the size of application 460 can be increased. In some implementations, various sizes, locations, and other changes can be made to promote the application from the user's point of view. In at least one implementation, the applications can be separated so that they do not overlap.

In some implementations, the system can be configured to determine the locations (and sizes) of the remaining applications (i.e., applications 461 and 462) based on settings associated with application 460. For example, application 460 may be associated with a setting that indicates the locations and size of the remaining applications in display view 406. In some implementations, the system can be configured to determine the locations (and sizes) of the remaining applications (i.e., applications 461 and 462) based on the preferences of the user. For example, the user can indicate a preference that application 461 be displayed to the right of application 460.

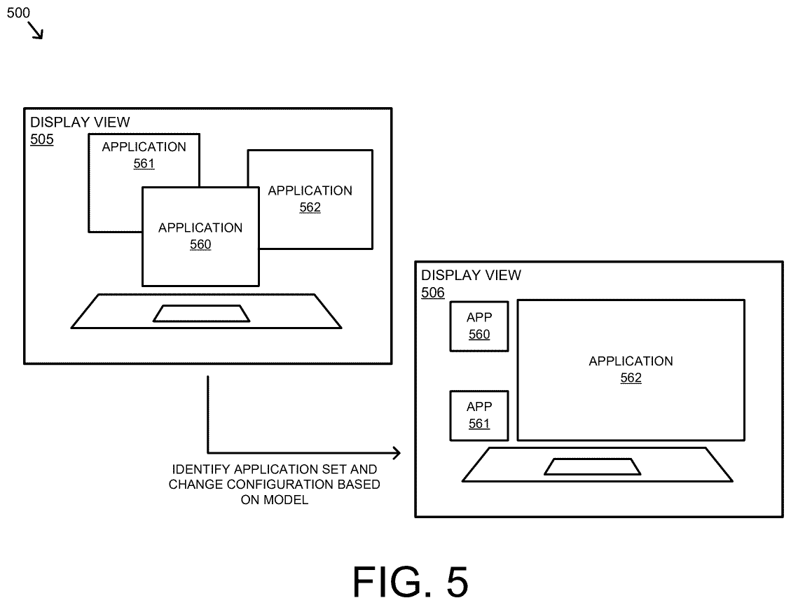

FIG. 5 illustrates an operational scenario 500 of updating a display configuration for applications according to an implementation. Operational scenario 500 includes display view 505 and display view 506 with applications 560, 561, and 562. Display views 505 and 506 represent a user's view from a wearable device, such as an XR device or smart glasses. Although demonstrated as separate applications, similar operations can be performed on different application windows for the same application. For example, similar operations can be performed for multiple instances of a web browsing application.

In operational scenario 500, the user is presented with display view 505, which includes a first configuration for displaying applications 560, 561, and 562. Here, in display view 505, applications 560, 561, and 562 are displayed with application 560 partially covering applications 561 and 562. In some implementations, users can use hand gestures or controllers to move applications on the display. As applications are opened or executed by the user, the display can become complicated to understand or process. For example, during research for a trip, the user may open multiple windows, including a notes application, a web browser, and an email application, to perform the desired research. These applications can be opened or moved in a way that obstructs the view of at least one window.

In some implementations, the system can be configured to identify a request (e.g., a verbal request) to update the display configuration associated with a set of applications. For example, the user can provide input of “Clean up.” The system can identify the request using natural language processing and determine the associated action. In some implementations, the device utilizes natural language processing to analyze the user's spoken or typed input, identifying intent and relevant entities. In some examples, natural language processing techniques like syntactic parsing and semantic analysis assist the system recognize action verbs (e.g., “clean,” “move,” “rearrange,” “organize”), objects (e.g., “applications,” “apps,” “windows,” “icons”), and contextual clues (e.g., “left side,” “top row,”). In some examples, intent classification models, which based on machine learning, interpret the overall meaning of the request, while entity recognition extracts specific details. The purpose of the processing can include identifying the intent of the user. The intent can be inferred using both the content of the user's speech and other contextual features, such as gestures, gaze, the current application types, or other features or context associated with device or user.

In some examples, the device can identify a specific set of words (e.g., “Clean up”). The device can utilize natural language processing to identify trigger words or phrases that trigger an action, such as rearranging the display of applications. Using the set of words, the device can determine that the user desires to rearrange the applications on the device.

In some examples, the system can use a model that outputs the new display configuration for the applications. In some examples, the model can utilize various inputs related to the device's state. The input features can include the types of applications on the screen, the time of day, current window sizes, recent application activity, or other state information associated with the applications. During the configuration or training process, the model can observe labeled examples of desired window configurations (e.g., either from user actions or curated data) and uses supervised or reinforcement learning to predict the desired configuration or layout for other applications based on the input features.

For example, the user can open three applications: a word processing application, an email application, and a web browser. The device can identify a request from a user to arrange the windows (e.g., “Clean up”) and can select positions and sizes for the windows based on training. In some examples, the model can be configured to receive inputs, such as the application type, the time of day, the user's gaze, or some other inputs. The inputs can then define the new configuration for the applications, relocating them to potentially desirable locations.

In another example, a user can open four applications on the device and provide voice input to rearrange or modify the configuration of the displayed applications. In response to the request, the system can identify various features associated with the request and update the display configuration accordingly. The features can include context provided by the user, such as voice instructions (move “X” application to the middle), gestures provided by the user during the instruction (e.g., pointing toward a particular application or group of applications), the gaze of the user during the instruction, and the like. The system can identify features associated with the applications, including the types of applications open by the user, the most recent input on the applications, user interactions with the applications, and similar information. The features can be identified as input for a model to produce a new configuration. In some examples, the model can be trained or configured using labeled examples of desired window configurations based on the features. The labeled examples can be used to configure or train the model to identify relevant features that correspond to potential configurations of the display. Once the features are extracted from the user's input (e.g., voice, gesture, or gaze) and the state of applications (e.g., application type, latest input, input history, or settings and preferences associated with the application), the system can determine a configuration for the four applications. As a technical effect, while a system can have a first configuration before the user's request, the device can update the configuration to support the user's intent. The system and model can use any number of features to support the display configuration for the applications.

In some examples, the system with the model can generate a set of potential configurations for the user based on the features and provide the potential configurations to the user. For instance, the model can rank candidate configurations based on a score from the features and provide a top set of candidates (e.g., top three). The user can then select the configuration from the set and the applications can be displayed in accordance with the selected configuration.

In some implementations, the examples described here can include systems and techniques that enable user interface (UI) control via a spatial action machine learning (ML) model. For example, the systems and methods described herein allow use of one or more ML models to utilize voice inputs, screen states, sensor inputs, and/or semantic graph(s) of applications to determine and provide (e.g., execute) an action(s) desired by a requesting user with respect to one or more UI(s).

At least one technical problem solved by the described techniques includes controlling UIs of applications. At least one technical problem solved by the described techniques includes providing user interface control for XR devices. At least one technical problem solved by the described techniques includes integrating or otherwise using multiple sensors to determine a user intent with respect to one or more UIs, while minimizing a number of steps required to be taken by the user to obtain a desired result.

At least one solution to the above and other technical problems includes providing one or more ML models and associated components that are enabled to interpret various types of inputs and determine associated actions, and that are enabled and authorized to execute the determined actions. Such solution(s) include determining a semantic graph(s) that represents an application(s) and/or UI(s), including representing a name, semantics, and function(s) of UI/application elements using corresponding nodes of the semantic graphs, while representing relationships between such nodes using edges of the semantic graphs. Then, the ML model(s) may be configured to process graphical inputs, to thereby process the semantic graphs in conjunction with various other potential inputs. Such potential inputs may include, e.g., voice requests from a user, motion/position data from motion sensors, image data from image sensors, gaze tracking data from gaze tracking sensors, or screen state information from an operating system of a device providing the UI(s)/application(s).

Described solutions thereby provide users with desired results, while requiring a minimum of information and explicit instruction from users. For example, while looking at a particular image, UI screen, or real world object, a user may ask “what is that?”, and described techniques may determine the object of the query, determine an associated application/UI to use to provide further information, and enter a relevant query into the determined application/UI to thereby display a desired response. As another example, the user can request to change the configuration of displayed applications, and the system can determine an updated configuration based on the request.

In other examples, described techniques may be used to provide results directly, effectively skipping over intermediate steps that would otherwise be required for the user to perform to obtain a desired result, and even if the user is not aware of the steps that would be needed to obtain the desired result. For example, a ML model constructed using described techniques may utilize a semantic graph of a system file structure. Described techniques may thus directly provide any available outcome within the file structure. The system can also use a semantic graph to associate and identify display configurations for different sets of applications.

For example, in a simplified example, the file structure may include a path for “connections” that includes “Bluetooth” and that further includes “connecting a new Bluetooth device.” The user may thus simply specify a request to connect a particular Bluetooth device, and the described techniques may then be used to establish the requested connection, and to do so in one step from the point of view of the user. In other words, the user is not required to navigate through, be aware of, or even be able to navigate through the various steps needed to establish a new Bluetooth connection. Similar operations can also be performed to select a display configuration for a set of applications.

As illustrated by the preceding examples, and as described in more detail, below, described techniques may thus be used to infer a nature of a user's request from a minimum of cues or other input or detail from the user. Described techniques may be further configured to provide a desired result to the user with a minimum of effort and/or knowledge being required from the user, including, e.g., executing one or more UI actions on the behalf of the user. Accordingly, users may be provided with experiences in which the users are able to reach desired outcomes in a fast and efficient manner.

In conventional systems, interactions in spatial computing devices (e.g., extended reality (XR) headsets) are enabled by a breadth of input/output capabilities (e.g., hand tracking or eye tracking), but nonetheless introduce high user friction, such as requirements on high physical motion and limited precision and/or bandwidth of inputs.

Described techniques provide interaction paradigms for spatialized computing, including using the uniqueness of the I/O (multimodal signals in real time) and solving for friction and precision. Such interaction paradigms redefine interactions with computing systems, including shifting away from sequential interactions to accomplish tasks, towards enabling users to directly move to those end states immediately.

One input paradigm is based on voice inputs, which may use less physical effort than other input modalities, in combination with a backend that enables semantic understanding of a relevant system(s) and interface(s), and is thus able to take context-aware actions and retain memory to perform complex tasks and interactions in support of an end to end user interaction(s).

Existing action-oriented voice interfaces may rely on a hardware-first verticalized approach, which exist as standalone applications or interfaces that do not contain context of the system, connection points across applications, or context across user interactions. Such conventional approaches are thus limited in their capabilities based on the architecture(s) of the solution(s) and therefore may not be able to perform complex tasks that enable broader user interactions and new interaction paradigms.

In contrast, described techniques redefine a human computer interaction paradigm, including spatial computing systems, and extending beyond to other form factors and platforms. Specifically, described techniques cover the usage of voice input powered by artificial intelligence (AI) that supports, e.g., conversational latency, extensive context length, and action-capable outputs, and that may be integrated deeply into the operating system of a device to support interactions on behalf of the user.

Relevant components may include, e.g., a voice interface, including transcription and parsing or prompt tuning. Components may include embedded AI, including spatial action models, as described herein, and which may support various inputs (such as, e.g., a spatial scene, context images, user behavior, and pointing locations) in addition to text input transcribed from voice inputs. With these and/or other inputs, a spatial action model may provide outputs as machine language that are mapped into interactions for the system experience.

In particular, action-based outputs, embedded into the system, may be provided by including wrapper models around or within the spatial action model(s) to be able to effectively output interactions. Deep integration points within the operating system may be provided to provide support for variants of interactions, including, e.g., in-app multi-stage user interactions, system interactions happening in parallel to user actions, and interactions that happen asynchronously to the user's supervision, but with the approval of the user.

For example, such interactions may be described in various interaction tiers, for the sake of illustration and example. For example, a single panel, single application, single shot input may result in reaching a defined goal in the context of a multi action end state. For example, a user may search a video in a video application from no initial state. In another example, a user may search a restaurant within a maps application, merely by looking at a panel or screen of the maps application and saying, “I want to book a restaurant for Sunday around <time range>, and I like this type of food <context>.”

In another example, a user of an email application may request an identification and summary of most relevant emails, including, where appropriate, initiating draft response emails, or opening relevant documents or slides. In other examples, a user may wish to plan a trip in an efficient manner and may request assistance in planning the trip to a specified location, for a specified time, and including activities that are based on the user's private preferences, e.g., “make me a trip plan to go to Italy for 5 days based on my preferences. Here are some things I want to make sure I cover: ( )” In these examples, the spatial action model described herein may take multiple actions across multiple websites and applications, thereby queuing up a summary for approval with a single shot booking proposal by the user. In some examples, the system can process the user's voice input to update the display of multiple applications. The update can be used to provide a desirable and efficient use of the available display space on the device.

In another example, a user may wish to purchase an item if/when a price of the item reaches a defined price. For example, the user may input, “I am looking for a new pair of sneakers, but they are currently out of my budget. Can you keep track of these shoes for me and buy them on my behalf across any site, once they have reached below <price>. Or alternatively, give me a prompt when a new pair is released and purchase if <conditions> are met.

In order for a multimodal spatial action model as described herein to provide these and other types of control of a system UI, the model may utilize a persistent memory of a relevant UI framework. For example, for one or more UIs and/or applications, a semantic graph may be maintained in which nodes represent UI states and edges represent input events. Graph nodes may then be associated with high-level semantics (e.g., learned offline).

In addition to the graph, visual and voice multimodal input may be mapped to these semantics to enable interactions in the system. Interactions may also be triggered by application intents, representing one instantiation of a depth-1 graph/tree. Such semantic graphs can be constructed using various techniques, some of which are described below as examples.

In some implementations, a wearable device, such as computing system 1200 of FIG. 12, can include an action manager application (or an action manager) that can be configured to execute actions using a user interface in response to requests from the user. In some implementations, the actions can include changing the configuration associated with the display of applications as described here. In some implementations, changing the display configuration can involve moving, resizing, or otherwise modifying the display of one or more applications. In some examples, the change in configuration can be based on the user's voice command, the gaze of the user, the selection of a current window, previous inputs of the user, identified preferences of the user, settings associated with the applications, or some other feature associated with the status of the display or the user input.

In the present description, the term action can be understood to represent or include any functionality of a relevant user interface. Such actions may therefore include, for example, selecting a user interface element (e.g., clicking on a clickable element), opening an application and corresponding user interface, inputting text or other data into a corresponding field (e.g., a text entry box), or interacting with any interactable element of the user interface. Actions may also include, for example, summarizing, translating, explaining, searching, or otherwise processing input from the and/or portions of one or more relevant user interfaces.

Actions executed by the action manager may thus replace, augment, or supersede input primitives commonly used for human-computer interaction (HCI). In the context of conventional HCI, the user may be required to follow a sequence of such input primitives to reach a desired state of a user interface, or other desired result. For example, in conventional contexts, if the user wishes to order takeout food from a nearby restaurant, the user might have to, e.g., open a web browser, enter text to search for nearby restaurants, navigate a menu of a selected restaurant, select a food delivery service, and finalize a purchase. In contrast, using the action manager, the user may simply specify, “order a French baguette from Panera Bread using Uber Eats,” and the action manager may execute the series of actions referenced above to thereby ultimately provide the user with a specified food item in a shopping cart of the specified food delivery service. In some implementations, if the user desires, the action manager may be provided with the authority to execute the transaction to consummate the purchase, while in other implementations, the action of finalizing the transaction may be required to be executed or approved by the user.

As may be observed from the preceding example, the action manager may control actions among multiple user interfaces and associated applications. For example, the action manager may use an output or result of a first action of the user interface as an input at the user interface.

It will be appreciated that conventional, existing systems for executing actions in response to a user request, such as a voice request, generally use a static dictionary or rulebook that enables implementation of an action in direct response to a user request. For example, a request such as “select the enter button” may be required to be implemented in a one-to-one fashion with execution of an action, so that a user is required to provide a series of instructions for actions that mirror the actions that such a user would have to take if using graphical user interface elements of the user interface.

In contrast, described techniques may provide a requested result, without requiring each intermediate action to be user-specified. As a result, user friction is reduced, and desired results may be obtained in a fast and efficient manner.

By virtue of the preceding examples, and following examples, the action manager may be understood to represent or provide a virtual assistant. Although various types of conventional virtual assistants exist, it will be appreciated that conventional virtual assistants do not provide the type of executed actions provided by the action manager. Such conventional virtual assistants further fail to provide the type of requested end results described herein, with the as-described ability to reduce or omit intervening user interface interactions in providing such requested end results.

Further, the action manager may utilize various types of multi-modal inputs to infer or otherwise determine an action to be executed. For example, inputs may include voice or other audio inputs from audio sensors, images from image sensors, pose/position data from motion sensors, or gaze data from gaze tracking devices. Inputs may further include screen captures of the screen (including screen states), as well as application data, system data, or other data stored using the memory of the device. For example, such data may include graph data representing one of the applications on the device and/or corresponding UIs or graph data representing personal preferences of the user.

These and various other inputs may be used by the action manager to determine an action(s) desired by the user. For example, as described in detail, below, the action manager may include a spatial action model that models actions, e.g., determination, selection, and implementation of such actions, with respect to the various types of inputs just referenced, and other types of inputs.

As a result, the user may be provided with desired actions quickly and efficiently, with minimal effort and minimal knowledge required. Consequently, the user may experience improvements, e.g., in learning, productivity, entertainment, communication, and health/wellness, some examples of which are provided herein.

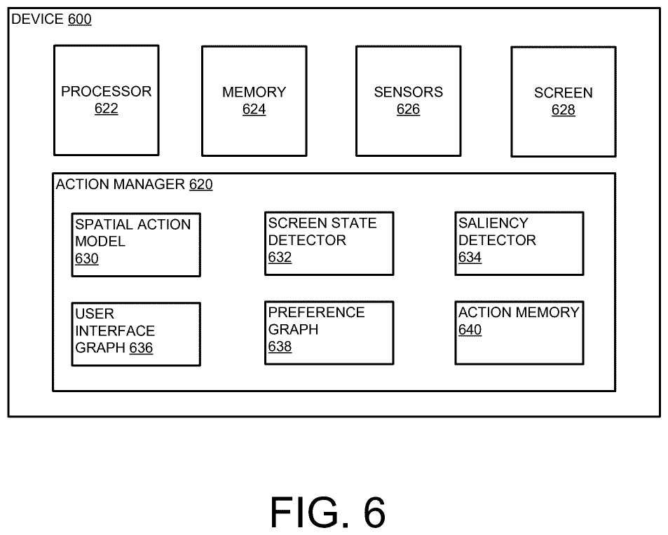

FIG. 6 illustrates a block diagram of a device 600 according to an implementation. In the example of FIG. 6, a device 600 represents any device that may be used to implement the action manager 620. For example, such devices may include smartphones, laptops, smartwatches, and many other devices, and combinations thereof. In some examples, action manager can be implemented by computing system 1200 of FIG. 12.

In FIG. 6, the device 600 is illustrated as including a processor 622, a memory 624, sensors 626, and a screen 628. Device 600 further includes memory 624, sensors 626, and screen 628. The processor 622 should be understood to represent any suitable processor(s) that may be used to execute instructions stored using the memory 624, including any relevant applications and the action manager 620.

The action manager 620 is illustrated as including a spatial action model 630. The spatial action model 630 should be understood to represent any suitable machine learning model and associated input/output layers, adapters, or wrappers that are trained to provide the type of multi-modal input processing described herein to thereby determine corresponding actions to be taken with respect to one or more user interfaces (and/or underlying application(s)). In some implementations, the system can change the display of applications or application windows on the device.

A screen state detector 632 may be configured to determine a current state of content of the screen 628. For example, the screen state detector 632 may determine one or more current user interfaces displayed using the screen 628, as well as current content being displayed, functions being provided, or instructions being executed. In the case of 3D XR environments, immersive applications may execute in a background state and may not be visibly displayed or rendered at a given point in time but may be captured and characterized by the screen state detector 632, as well. Moreover, as the screen 628 may display a current real-world view (e.g., in a passthrough mode of an XR device, or when viewing an image capture screen of a smartphone), the screen state detector 632 should be understood to capture or include real-world objects/views, as well as rendered content.

A saliency detector 634 may be configured to process a screen state determined by the screen state detector 632, in order to assess most-relevant or most-salient state data to be supplied to the spatial action model at a given point in time. For example, in a 3D XR immersive environment, the user may be provided with a 360-degree view and may potentially view multiple panels simultaneously or may view a single user interface that spans the entire field of view of the user.

The saliency detector 634 may be configured to determine, e.g., based on various other inputs, including, e.g., voice inputs from the user, most-relevant portions of the screen 628 and/or provided screen content or data. For example, the user may express an otherwise ambiguous request, such as, “what is that?”, or “what do I see here?”, and the saliency detector 634 may utilize gaze-tracking data from a gaze-tracking device of the sensors 626 to identify a restricted field of view most likely to correspond to the request. In this way, the saliency detector 634 may effectively disambiguate the request in a fast and efficient manner and increase an accuracy of a provided response.

A user interface graph 636 refers to a graphical representation of one or more user interfaces and/or applications currently stored/available, e.g., using the memory 624. For example, all applications currently open, in use, or available for use may be included, including applications that may be executing on a second or remote device.

In the present description, a user interface graph refers to any graph that represents available or potential user interface states and associated actions that may be performed with respect to the user interface(s). Multiple user interfaces may be associated with one application, and multiple user interfaces across multiple applications may be included in the user interface graph 636. In the present description, user interfaces graphs may include, or be referred to as, action graphs, state graphs, or semantic graphs, which are examples or instances of user interface graphs and therefore may vary somewhat in terms of, e.g., how different types of such graphs are constructed and what types of user interface information is included in such graphs.

For example, the action manager 620 may have access to an application-specific semantic graph for many different applications that may be executable by the device 600, across many different users. Each such application-specific semantic graph may include varying types of data and/or levels of detail used to characterize a corresponding application.

For example, some commonly used applications and/or smaller applications may include detailed semantic graphs that characterize all or virtually all application functions or aspects. Semantic graphs for other applications may include a high level of detail with respect to top or high level application functions or user interface screens, with less detail included for lower-level functions/screens that are used less often. Further, for a single application layer or UI screen, some portions that are static or relatively less likely to change may be mapped and graphed in detail, while other, more dynamic portions may be graphed in less detail.

Such application mappings may also change over time. For example, as a new application becomes available or is added, an initial semantic graph may be added, as well. As one or more users use the application, the semantic graph may be updated and extended over time. Further, as a given application experiences updates or other changes, the corresponding semantic graph may be updated, as well.

In some cases, existing application graphs may be accessed, stored, or otherwise leveraged to construct a corresponding semantic graph for the corresponding applications. For example, widely used applications may provide, or make accessible, publicly available application graphs that assist application developers in developing new, compatible applications, and such available application graphs may be used, e.g., augmented, to construct semantic graphs that are usable by the spatial action model 630.

The specific user, at a given point in time, may have some subset of applications stored using the memory 624 or accessed via a network, and currently open, active, or available. The user interface graph 636 (which may be a semantic graph or global semantic graph) may combine or simultaneously access corresponding application semantic graphs on behalf of the user, for processing by the spatial action model 630. Accordingly, the user interface graph 636 may be referred to as a global semantic graph or a user-specific semantic graph, to indicate inclusion of multiple application-specific semantic graphs.

For example, as described herein, the spatial action model 630 may utilize multiple applications to achieve a desired result or action. For example, the spatial action model 630 may traverse the user interface graph 636 using the output of a first application, obtained by executing a first action as input to a second application, thereby executing a second action. Thus, by traversing various portions of the user interface graph 636, the spatial action model 630 is capable of providing a desired result across multiple levels of multiple applications.

In addition, a preference graph 638 may be constructed with respect to the individual user. The preference graph 638 may provide, for example, preferences of the user with respect to desirable content, actions to be provided or avoided, and various manner(s) in which provided actions may be provided.

As a result, for example, the spatial action model 630 may provide actions even without a direct query from the user. For example, if image sensors and/or the screen 628 provide images of content that may be of interest to the user based on the preference graph 638, the spatial action model 630 may automatically select an application(s) and execute an action(s) to obtain relevant or useful information for the user.

Such information may be surfaced to the user immediately, or stored for later use, e.g., using an action memory 640. For example, if the user is wearing the device as AR glasses, the AR glasses may capture an item in the field of view of the user that the user may not actively notice or designate, but that the spatial action model 630 determines to be relevant to the preference graph 638.

In these and other scenarios, the spatial action model 630 may thus output relevant information, e.g., by opening a relevant search application, entering text or images related to the recognized content, and storing received search results. The spatial action model 630 may execute these actions in real time and demonstrated to the user in a rendered user interface(s) or may do so in a background process not visible to the user. In the latter case, the spatial action model 630 may store search results and related information in the action memory 640, which may then be reviewed later by the user in a batch fashion.

The action memory 640 may be used for other purposes. For example, the action memory 640 may be used to store session information for one or more action sessions of the user. For example, the spatial action model 630 may thus be provided with an ability to use earlier action executions and related information as input(s) to determining a current action to be executed. For example, the user may ask an initial question about a book viewed using the screen 628 early in a session, and then later in the session, might ask a related question, such as, “can you provide a summary of the book I asked about earlier?”, without having to view or otherwise designate the book again at that time. Accordingly, the user may again be provided with fast, efficient access to desired actions by the action manager 620.

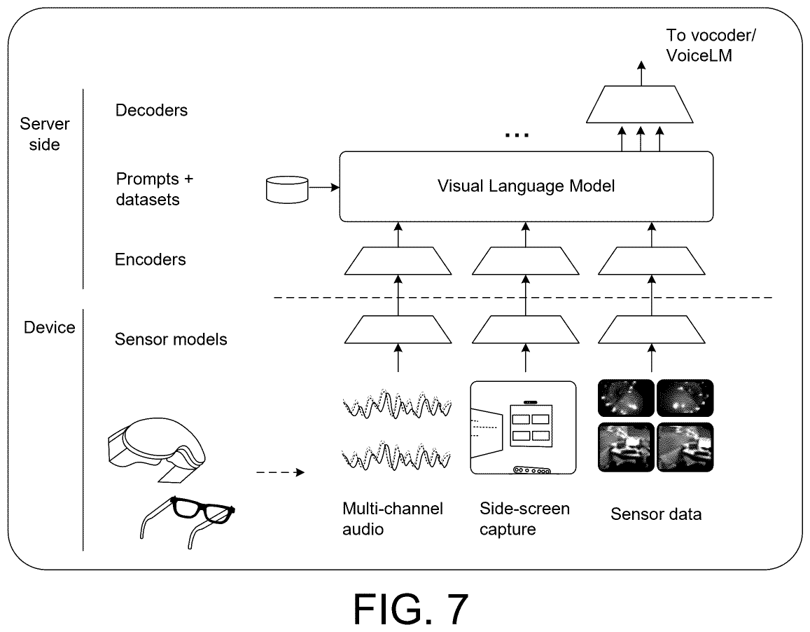

FIG. 7 illustrates a first example implementation of a spatial action model. In the example of FIG. 7, at a device/hardware abstraction layer (HAL), one or more devices (e.g., XR devices) provide multi-channel audio, wide screen capture, and other types of sensor data.

Sensor models corresponding to the various illustrated multi-modal inputs may then process the corresponding ones of the inputs. For example, a sensor model may process the multi-channel audio to denoise the audio and otherwise process and filter the audio to isolate user voice commands.

A sensor model may process widescreen capture data. The sensor model may relate visual/screen data to corresponding user interfaces and applications, and thus to corresponding application semantic graphs. Techniques for related visual/screen data to graph data are described in more detail below.

A sensor model(s) may process sensor data from one or more of the various types of usable sensors, including image sensors, motion sensors (e.g., inertial measurement units (IMUs)), and gaze-tracking sensors. For example, sensor data may be filtered or otherwise processed, including various types of sensor fusion.

Corresponding encoders may be configured to input the processed sensor data for subsequent input to a visual language model (VLM). For example, an encoder, e.g., including a conformer, may be configured to model local/global audio sequence dependencies of audio sequences received from the underlying audio sensor model processing the multi-channel audio.

An encoder may receive screen/visual/graph data for tokenization and input to the VLM. The encoder may be implemented, for example, using a contrastive captioner (Coca) in PyTorch with vector quantization (VQ). The encoder may be implemented as one or more translators for a large language model (LLM), such as the VLM, to tokenize graph data, where the encoder weights may be fine-tuned using, e.g., XR/AR specific data (e.g., images, screens). Further, various types of weight modification, such as Low-Rank Adaption (LoRA) may be used to effectively reduce a number of parameters required for training and inference, thereby providing efficient fine-tuning without retraining an entire model, and reducing associated memory requirements for storing the trained encoder.

One or more customer encoders may be used to convert processed sensor data for input to the VLM. For example, different encoders may be used when underlying sensor data incudes image, pose/position, and/or gaze sensor(s).

In FIG. 7, the VLM may thus represent any suitable visual large language model compatible with inputs from the encoders. Also in FIG. 7, prompt data may be used so that prompts for the VLM are customized and engineered to obtain desired results. For example, prompt templates for commonly requested or needed actions may be provided. Further, the VLM may be trained to provide desired actions based desired prompts or prompt templates. Outputs of the various encoders may be combined with, or modified by, the stored prompts to improve outputs of the VLM.

Retrieval augmented generation (RAG) data may also be used to improve or facilitate operations of the VLM in conjunction with outputs of the various encoders. RAG data, for example, may include application data for many different applications, some or all of which may be included in a global semantic graph of a user, such as the user. In this way, as described in more detail, below, requirements for creating the global semantic graph(s) may be reduced, and existing application data/graphs may be leveraged to ensure availability and use of many different applications in the system of FIG. 7.

A customer wrapper may be provided that translates textual and/or image outputs of the VLM into the types of actions described herein, including, e.g., including opening applications, entering text into user interfaces, making selections, generating virtual assets, or providing pointers to real world objects. For example, the customer wrapper may be implemented by translating textual outputs of the VLM to Python or other suitable code, as input to a suitable application program interface (API), and/or as a generated API.

To determine an appropriate action, the wrapper may be implemented as a decoder that is a classifier that classifies outputs of the VLM into at least one action class. In such examples, the wrapper may be implemented as a small footprint neural network that converts text strings into one of a plurality of action classes.

In the example of FIG. 7, the various encoders may each have a control token(s) when inputting to the VLM. Thus, any of the encoders may invoke an action. For example, the graph encoder encoding semantic graphs of associated user interfaces may include a control token, so that, as referenced above, input of a screen or other image, by itself or in conjunction with other data (but not requiring voice data or other direct or synchronous input from the user), may invoke an action(s). For example, as referenced, the preference graph and a captured image/screen may be sufficient to trigger an action such as a search for data related to the captured image/screen, even without a corresponding request from the user.

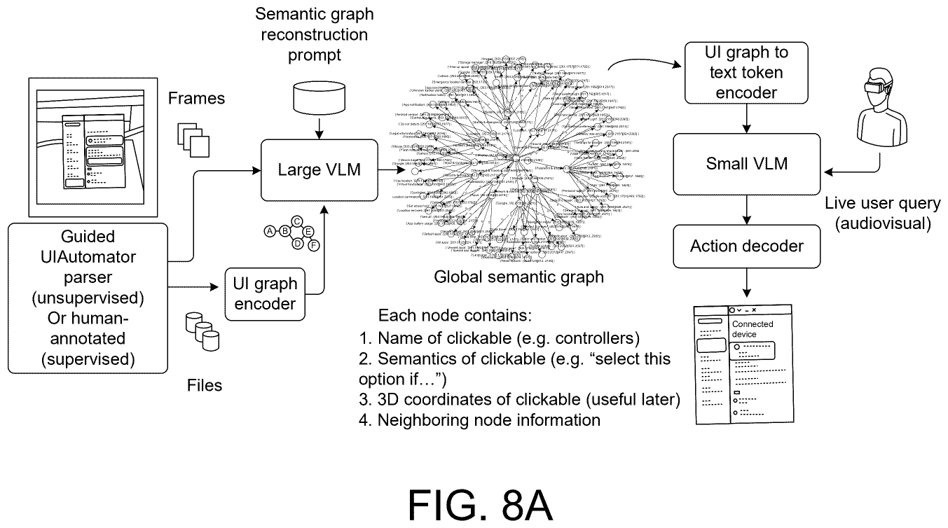

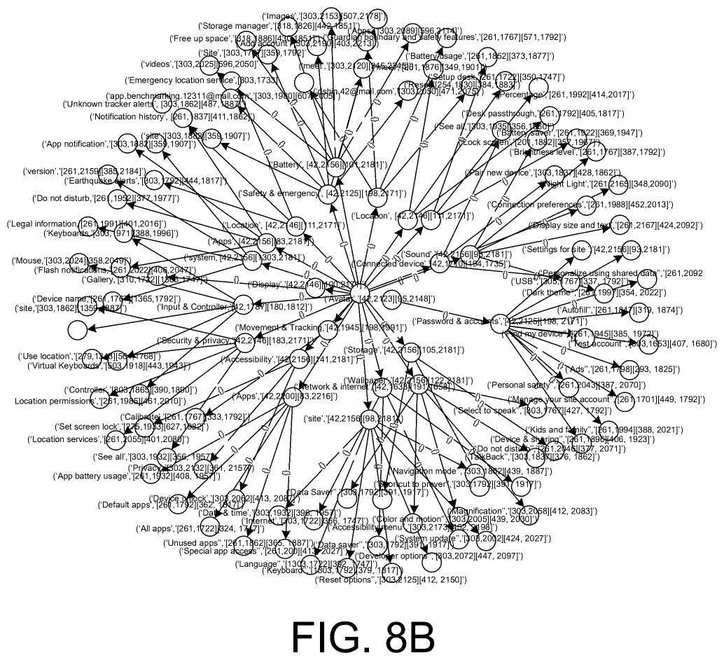

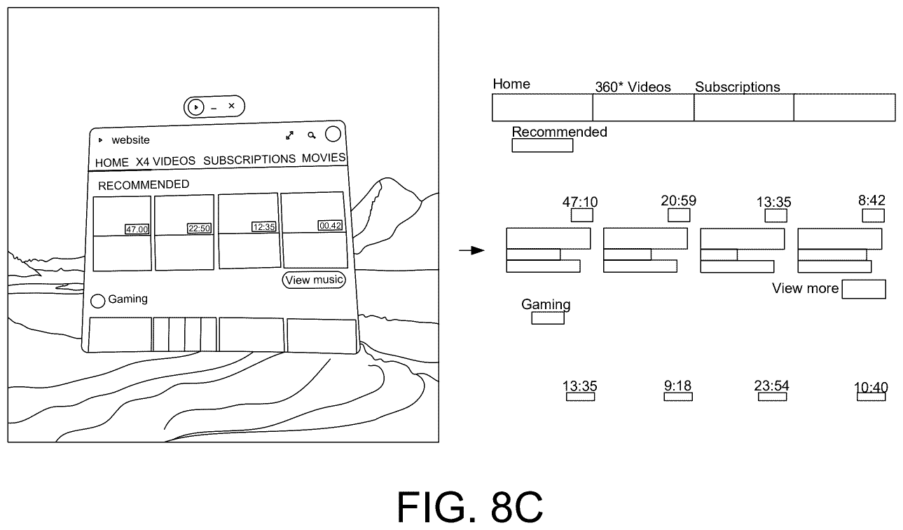

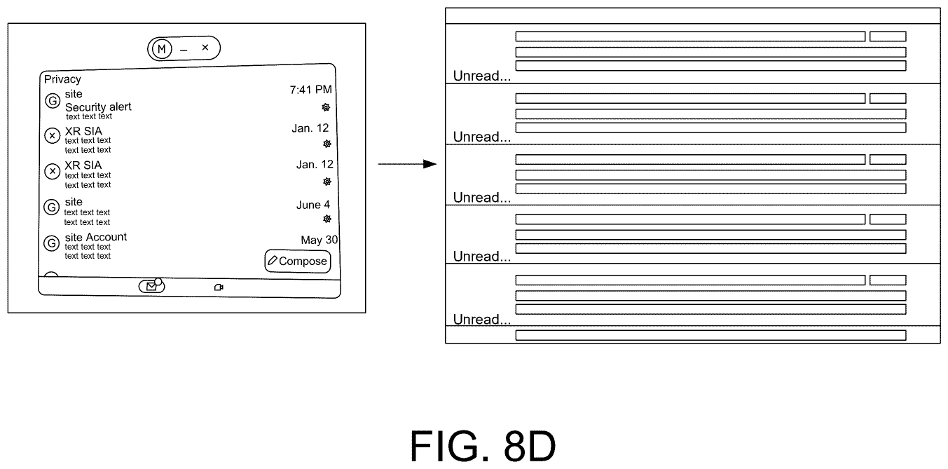

FIG. 8A is a block diagram illustrating a second example implementation of a spatial action model. In FIG. 8A, a UI parser may be implemented, e.g., using unsupervised or supervised techniques. For example, in the latter case, applications/user interfaces may be human annotated for processing.

For example, as shown in the examples of FIGS. 8C and 8D, UI screens may undergo a process of sparsification, in which extraneous images and data are removed and the remaining data is converted to formatted text, e.g., in extensible Markup Language (XML), and stored in XML files. Meanwhile, screen/image frames may be captured at a given frame rate per second (fps), e.g., using circular prediction mapping (CPM) for coding image sequences.

For example, image frames may be captured, and relevant positions and elements, such as those appropriate for action inference, of user interfaces may be identified. For example, a clickable or selectable element may be identified, and an associated position, e.g., in pixel coordinates, may be captured. Thus, for each image/screen, action-relevant portions may be quantified, identified, localized, and otherwise characterized.

A UI graph encoder may transform the XML files into graph-based representations, such as graphical embeddings or tokens, that are compatible with a large VLM. In this context, the large VLM should be understood to be of a size (in terms of the number of parameters, memory footprint, and associated processing resources) that can handle multiple different applications. For example, the large VLM may be implemented as a server-side VLM. In conjunction with one or more semantic graph reconstruction prompts, the large VLM may thus be configured to determine a semantic graph capable of representing any combination of processed applications.

As shown in FIG. 8B, the semantic graph may include many nodes, connected by edges representing relationships between the nodes. For example, each node may consist of a name of an element, including clickable elements or other controller elements. Each node may include semantics of its corresponding element, such as “select this option if . . . ”. A node may contain information regarding neighboring nodes. A node may also contain coordinates, e.g., 2D or 3D coordinates, within a relevant user interface.

Further in FIG. 8A, a UI graph to text token encoder may interface with the semantic graph. A small VLM, e.g., operable on a user device of a user, may receive an audiovisual or other multimodal query from the user.

Thus, the small VLM may process relevant aspects of the semantic graph together with the multimodal query and action decoder, as an example of the type of customer wrapper, may be configured to determine a relevant action. In the example, the semantic graph may include a connection file structure for a device, including various types of wireless connections. Therefore, like the example provided above, the user may provide the query, “establish a Bluetooth connection for this device”, and the semantic graph may be used to move to the appropriate connection screen and connect the device in the requested manner, without requiring the user to navigate through the connection file structure.

FIG. 8A illustrates that applications may be onboarded in a manner that does not require input or assistance from application developers, e.g., does not require an application to be constructed in a particular manner or include any particular metadata. XML representations of application pages with relevant pixel coordinates determined from synchronized CPM frames (which may include 3D or stereoscopic image frames) enable a graphical, 3D spatial representation of action-relevant user interface aspects, to thereby enable construction and updating of the semantic graph.

Many additional or alternative techniques may be used to generate and maintain the semantic graph. For example, heuristics-based approaches may be used in which existing data on application is polled to determine application/user interface features and aspects with associated levels of confidence.

For example, as referenced above, and as may be observed with respect to FIGS. 8C and 8D, portions of some user interfaces may be determined to be relatively static over time and with respect to other portions of the same user interfaces. For example, in the context of an email application as shown in FIG. 8D, the structure of the page may be generally or relatively static, while content of individual emails may change rapidly/dynamically.

In many cases, an application may be onboarded with a minimum level of mapping to a corresponding semantic graph, and then improvements may be made over time to enable a more complete semantic graph for the application. For example, semantic graph updates may occur in conjunction with tracking user interactions across multiple users, and/or in conjunction with application updates.

Initial application onboarding may also be performed by application type, so that multiple applications of a similar type may be onboarded quickly. For example, again with respect to the example of FIG. 8D, multiple email applications may share similar features, e.g., related to an inbox, sending/receiving email, etc., and such similarities may be leveraged in generating an initial semantic graph that applies (with appropriate modifications) to multiple applications of the application type.

In some examples, RAG application data may also be leveraged. For example, application structural data may be available from application providers and can be used, e.g., as an external RAG data source, which can then be combined with the semantic graph (or subsets thereof) to determine appropriate actions.

During query processing and other action determinations, the small VLM is thus enabled to perform various degrees of graph traversal to determine a correct and desired action. For example, when the semantic graph (including any relevant RAG data) includes a graphical path to a desired action, then the action decoder may determine, provide, and potentially execute a desired action without requiring the user to navigate through intervening graph nodes (e.g., user interface elements). Such traversals may occur, for example, when navigating through fully static frameworks, such as the example of establishing a Bluetooth connection.

In other examples, varying degrees of navigation steps may be requested to obtain a desired action. For example, in response to a user request, the small VLM and the action decoder may determine the farthest node available in an initial graph traversal. Then, the user may be presented with screen(s) in which the user may proceed by specifying more specific input primitives, such as, e.g., “select this button”, until a desired end point action is reached.

As noted above, screen states may thus be relevant to decisions made by the small VLM in conjunction with relevant portions of the semantic graph. For example, a current state of a user interface screen may dictate a starting point for subsequent graph traversals.

In some examples, traversals may be initiated based on user-expressed intentions, without reference to any existing screen state. For example, even when no user interface is present or no application is opened, the user may request booking of a reservation at a specified time, date, and location, and the small VLM may, e.g., open a website or scheduling application, enter requested parameters, open other websites (e.g., nearby restaurants of relevant food types), select open times, and otherwise schedule the reservation.

In many cases, actions may be classified with respect to a degree of impact or other parameter that may be relevant to executing actions. Then, high-impact actions may be indicated to request approval from the user prior to executing a corresponding action. For example, actions related to purchases may require express approval from the user, while actions related to executing a search may not.

FIG. 8B is an example semantic graph that may be used in the implementation of FIG. 8A. FIG. 8C illustrates a first example of page sparsification that may be used in the implementation of FIG. 8A. FIG. 8D illustrates a second example of page sparsification that may be used in the implementation of FIG. 8A. As shown in FIGS. 8B and 8C, static, structural elements of a user interface may be extracted, and individual pieces of content may be removed to be able to learn page structure that can then be embedded into the type of graph illustrated in FIG. 8B.

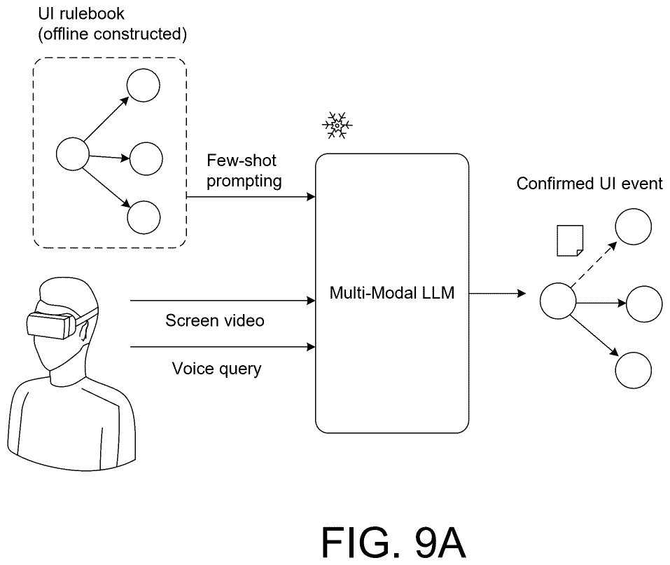

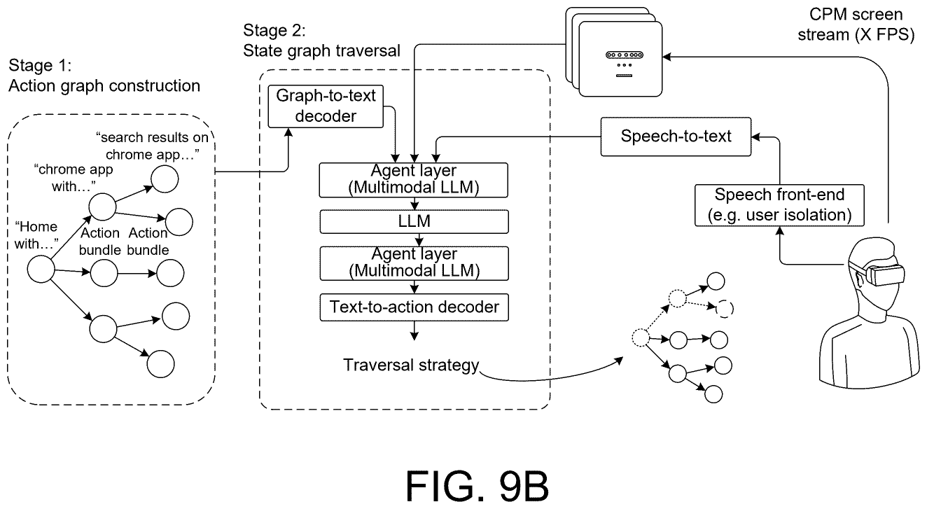

FIG. 9A is a block diagram illustrating a third example implementation of a spatial action model. In the example of FIG. 9A, a UI rulebook may be constructed offline that captures a set of desired and available actions. In contrast with the example of FIG. 8A, the UI rulebook is not required to include a full semantic graph, but rather may include a set of prompts that correspond to specified actions and, when submitted to a multi-modal VLM in conjunction with screen video and a received voice query, cause the multi-modal VLM to perform the desired action(s) as corresponding UI events.

For example, the UI rulebook may include textual descriptions of actions expressed as, or describing, machine language (e.g., an API call) for performing a corresponding action, such as opening a particular application. The few-shot prompting may include all actions that the user may want to invoke, with instructions to execute only those actions of the UI rulebook that relate to the screen video/voice query inputs.

Advantageously, the implementation of FIG. 9A can be constructed quickly and easily for various specific use cases and does not require the same type or extent of encoders, transformers, decoders, or wrappers in conjunction with the VLM. For example, the UI rulebook may be constructed entirely textually, without requiring a graph embedding to be processed accurately by the multi-modal VLM. Consequently, the approach of FIG. 9A may be deployed rapidly. On the other hand, the approach of FIG. 9A may be more difficult to adapt or update over time, as new applications, features, or actions are developed, and may be more difficult to deploy widely across many different contexts and use cases.

FIG. 9B is a block diagram illustrating a fourth example implementation of a spatial action model. In contrast to FIG. 9A, the implementation of FIG. 9B utilizes a semantic graph or state graph, which may be processed by a graph-to-text decoder and provided to a multimodal VLM agent. The multi-modal VLM agent also receives a CPM stream of screen frames at a given frame rate (fps) and text converted from received speech of a user.

A VLM may thus process these inputs received view the multi-modal VLM agent, and following additional processing by a back-end multi-modal VLM agent, a text-to-action decoder may be configured to provide a traversal strategy defined with respect to the original semantic graph or state graph.

In contrast to FIGS. 8A and 8B, the implementation of FIG. 9B may not require or utilize a full semantic graph that specifies pixel coordinates of elements, e.g., in an XR environment. For example, the state graph of FIG. 9B may represent an available state graph of a given application or operating system feature(s), such as in the Bluetooth examples provided above. The state graph of FIG. 9B may grow or be modified or updated over time, based on user interactions with the state graph. Also, in contrast to FIGS. 8A and 8B, the implementation of FIG. 9B may require little or no special prompting or prompt engineering, so that it is not necessary to have a set of textual descriptions of (aspects of) desired actions.

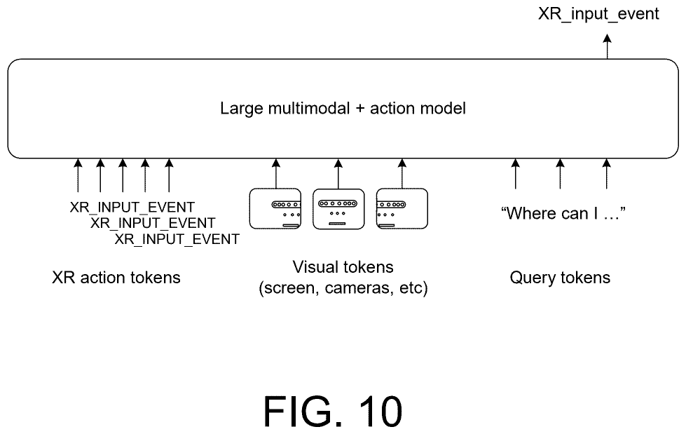

FIG. 10 is a block diagram illustrating a fifth example implementation of a spatial action model. In the example of FIG. 10, a single model is constructed that includes a large multimodal model and an action model. The model of FIG. 10 may thus receive any number of XR action tokens associated with input events, visual tokens, and query tokens, and directly output or execute an action, e.g., input event for a relevant user interface.

In some examples, the implementation of FIG. 10 does not require separate custom encoders, decoders, or wrappers, nor does it require prompt engineering. On the other hand, the implementation of FIG. 10 may require comparatively greater efforts in training the large multimodal and action model.

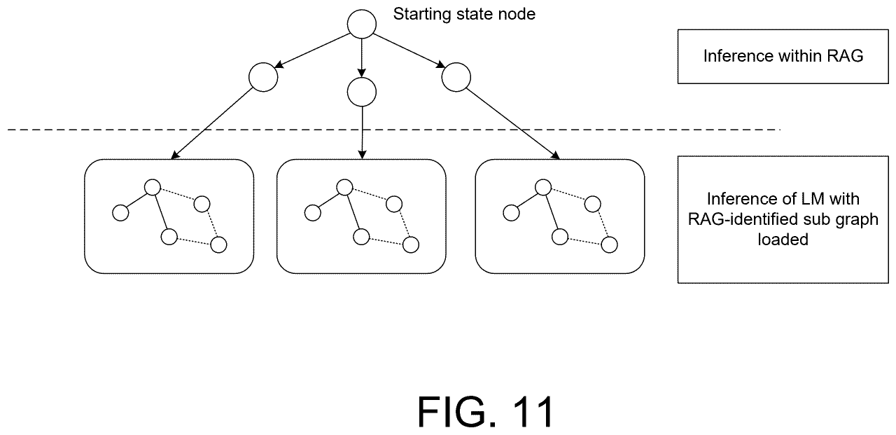

FIG. 11 is a block diagram illustrating a sixth example implementation of a spatial action model. FIG. 11 utilizes the type of RAG approach described above, in which an external knowledge base is used to supplement or support semantic graph construction and processing.

For example, as referenced above, many applications may ship with, or otherwise have available, a graphical representation of their core functions and application states. By themselves, such graphs may not be suitable or sufficient for the types of action graphs described herein and may not be easily or sufficiently adaptable to provide described features. Moreover, even if such graphs can be adapted or generated, it may be problematic to incorporate all such applications that a given user(s) may desire to utilize in the context of a single global semantic graph.

Instead, as shown in FIG. 11, an initial inference of a desired action, or a desired subset of a graph, may be performed using RAG techniques. Then, a RAG-identified subgraph may be loaded and used to perform the types of further graph analysis described above. In various implementations, more or less local memory resources may thus be used, with corresponding decreases/increases in action latency, depending on user or administrator preferences.

FIG. 12 illustrates a computing system 1200 to provide an updated display configuration according to an implementation. Computing system 1200 is representative of any computing system or systems with which the various operational architectures, processes, scenarios, and sequences disclosed herein can be implemented to change a display configuration based on user input. Computing system 1200 may represent a wearable computing device, such as an XR device or smart glasses. Computing system 1200 can include multiple computing devices in some examples (e.g., a wearable device and a companion device, such as a smartphone or tablet). Computing system 1200 includes storage system 1245, processing system 1250, communication interface 1260, and input/output (I/O) device(s) 1270. Processing system 1250 is operatively linked to communication interface 1260, I/O device(s) 1270, and storage system 1245. In some implementations, communication interface 1260 and/or I/O device(s) 1270 may be communicatively linked to storage system 1245. Computing system 1200 may further include other components, such as a battery and enclosure, that are not shown for clarity.

Communication interface 1260 comprises components that communicate over communication links, such as network cards, ports, radio frequency, processing circuitry and software, or some other communication devices. Communication interface 1260 may be configured to communicate over metallic, wireless, or optical links. Communication interface 1260 may be configured to use Time Division Multiplex (TDM), Internet Protocol (IP), Ethernet, optical networking, wireless protocols, communication signaling, or some other communication format, including combinations thereof. Communication interface 1260 may be configured to communicate with external devices, such as servers, user devices, or some other computing device.

I/O device(s) 1270 may include computer peripherals that facilitate the interaction between the user and computing system 1200. Examples of I/O device(s) 1270 may include keyboards, mice, trackpads, monitors, displays, printers, cameras, microphones, external storage devices, and the like.

Processing system 1250 comprises microprocessor circuitry (e.g., at least one processor) and other circuitry that retrieves and executes operating software from storage system 1245. Storage system 1245 may include volatile and nonvolatile, removable, and non-removable media implemented in any method or technology for information storage, such as computer-readable instructions, data structures, program modules, or other data. Storage system 1245 may be implemented as a single storage device but may also be implemented across multiple storage devices or sub-systems. Storage system 1245 may comprise additional elements, such as a controller to read operating software from the storage systems. Examples of storage media (also referred to as computer-readable storage media) include random access memory, read-only memory, magnetic disks, optical disks, and flash memory, as well as any combination or variation thereof or any other type of storage media. In some implementations, the storage media may be non-transitory. In some instances, at least a portion of the storage media may be transitory. In no case is the storage media a propagated signal.

Processing system 1250 is typically mounted on a circuit board that may hold the storage system. The operating software of storage system 1245 comprises computer programs, firmware, or another form of machine-readable program instructions. The operating software of storage system 1245 comprises display application 1224. The operating software on storage system 1245 may include an operating system, utilities, drivers, network interfaces, applications, or other types of software. When read and executed by processing system 1250 the operating software on storage system 1245 directs computing system 1200 to operate as described in the previously described FIGS.

Below are example clauses associated with the present disclosure. The described clauses should not be considered exhaustive.

Clause 1. A method comprising: receiving voice input from a user of a device; determining that the voice input satisfies at least one criterion associated with a first configuration of virtual objects on a display of the device; and in response to the voice input satisfying the at least one criterion, changing the first configuration of the virtual objects to a second configuration of the virtual objects.

Clause 2. The method of clause 1, wherein changing the first configuration of the virtual objects to the second configuration of the virtual objects comprises moving a first virtual object of the virtual objects from a first location on the display to a second location on the display.

Clause 3. The method of clause 1, wherein changing the first configuration of the virtual objects to the second configuration of the virtual objects comprises changing a first virtual object of the virtual objects from a first size to a second size.

Clause 4. The method of clause 1 further comprising: determining a gaze associated with the user, wherein changing the first configuration of the virtual objects to the second configuration of the virtual objects comprises changing the first configuration of the virtual objects to the second configuration of the virtual objects based on the gaze.

Clause 5. The method of clause 1, wherein the first configuration comprises a first virtual object of the virtual objects overlaid on a second virtual object of the virtual objects, and wherein the second configuration comprises the first virtual object not overlaid on the second virtual object.

Clause 6. The method of clause 1, wherein the first configuration comprises a first virtual object of the virtual objects overlaid on a second virtual object of the virtual objects, and wherein the second configuration comprises an arrangement of the first virtual object relative to the second virtual object based on a preference of the user.

Clause 7. The method of clause 1 further comprising: identifying a first virtual object of the virtual objects on the display of the device; identifying at least one setting associated with the first virtual object; and determining the second configuration of the virtual objects based on the at least one setting associated with the first virtual object.

Clause 8. The method of clause 1 further comprising: identifying at least one virtual object of the virtual objects on the display of the device; and obtaining the second configuration from a model configured to provide the second configuration based on the at least one virtual object.

Clause 9. A system comprising: a computer-readable storage medium; at least one processor operatively coupled to the computer-readable storage medium; and program instructions stored on the computer-readable storage medium that, when executed by the at least one processor, direct the system to perform a method, the method comprising: receiving voice input from a user of a device; determining that the voice input satisfies at least one criterion associated with a first configuration of virtual objects on a display of the device; and in response to the voice input satisfying the at least one criterion, changing the first configuration of the virtual objects to a second configuration of the virtual objects.

Clause 10. The system of clause 9, wherein changing the first configuration of the virtual objects to the second configuration of the virtual objects comprises moving a first window for the virtual objects from a first location on the display to a second location on the display.

Clause 11. The system of clause 9, wherein changing the first configuration of the virtual objects to the second configuration of the virtual objects comprises changing a first virtual object of the virtual objects from a first size to a second size.

Clause 12. The system of clause 9, wherein the method further comprises: determining a gaze associated with the user, wherein changing the first configuration of the virtual objects to the second configuration of the virtual objects comprises changing the first configuration of the virtual objects to the second configuration of the virtual objects based on the gaze.

Clause 13. The system of clause 9, wherein the first configuration comprises a first virtual object of the virtual objects overlaid on a second virtual object of the virtual objects, and wherein the second configuration comprises the first virtual object not overlaid on the second virtual object.

Clause 14. The system of clause 9, wherein the first configuration comprises a first virtual object of the virtual objects overlaid on a second virtual object of the virtual objects, and wherein the second configuration comprises an arrangement of the first virtual object relative to the second virtual object based on a preference of the user.

Clause 15. The system of clause 9, wherein the method further comprises: identifying at least one virtual object of the virtual objects on the display of the device; and obtaining the second configuration from a model configured to provide the second configuration based on the at least one virtual object.

Clause 16. A computer-readable storage medium storing executable instructions that, when executed by at least one processor, cause the at least one processor to execute a method, the method comprising: receiving voice input from a user of a device; determining that the voice input satisfies at least one criterion associated with a first configuration of virtual objects on a display of the device; and in response to the voice input satisfying the at least one criterion, changing the first configuration of the virtual objects to a second configuration of the virtual objects.

Clause 17. The computer-readable storage medium of clause 16, wherein changing the first configuration of the virtual objects to the second configuration of the virtual objects comprises moving a first window for the virtual objects from a first location on the display to a second location on the display.

Clause 18. The computer-readable storage medium of clause 16, wherein changing the first configuration of the virtual objects to the second configuration of the virtual objects comprises changing a first window for the virtual objects from a first size to a second size.

Clause 19. The computer-readable storage medium of clause 16, wherein the method further comprises: determining a gaze associated with the user, wherein changing the first configuration of the virtual objects to the second configuration of the virtual objects comprises changing the first configuration of the virtual objects to the second configuration of the virtual objects based on the gaze.

Clause 20. The computer-readable storage medium of clause 16, wherein the method further comprises: identifying at least one virtual object of the virtual objects on the display of the device; and obtaining the second configuration from a model configured to provide the second configuration based on the at least one virtual object.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that when executed cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
receiving voice input from a user of a device;
determining that the voice input satisfies at least one criterion associated with a first configuration of virtual objects on a display of the device; and
in response to the voice input satisfying the at least one criterion, changing the first configuration of the virtual objects to a second configuration of the virtual objects.

2. The method of claim 1, wherein changing the first configuration of the virtual objects to the second configuration of the virtual objects comprises moving a first virtual object of the virtual objects from a first location on the display to a second location on the display.

3. The method of claim 1, wherein changing the first configuration of the virtual objects to the second configuration of the virtual objects comprises changing a first virtual object of the virtual objects from a first size to a second size.

4. The method of claim 1 further comprising:
determining a gaze associated with the user,
wherein changing the first configuration of the virtual objects to the second configuration of the virtual objects comprises changing the first configuration of the virtual objects to the second configuration of the virtual objects based on the gaze.

5. The method of claim 1, wherein the first configuration comprises a first virtual object of the virtual objects overlaid on a second virtual object of the virtual objects, and wherein the second configuration comprises the first virtual object not overlaid on the second virtual object.

6. The method of claim 1, wherein the first configuration comprises a first virtual object of the virtual objects overlaid on a second virtual object of the virtual objects, and wherein the second configuration comprises an arrangement of the first virtual object relative to the second virtual object based on a preference of the user.

7. The method of claim 1 further comprising:
identifying a first virtual object of the virtual objects on the display of the device;
identifying at least one setting associated with the first virtual object; and
determining the second configuration of the virtual objects based on the at least one setting associated with the first virtual object.

8. The method of claim 1 further comprising:
identifying at least one virtual object of the virtual objects on the display of the device; and
obtaining the second configuration from a model configured to provide the second configuration based on the at least one virtual object.

9. A system comprising:
a computer-readable storage medium;
at least one processor operatively coupled to the computer-readable storage medium; and
program instructions stored on the computer-readable storage medium that, when executed by the at least one processor, direct the system to perform a method, the method comprising:
receiving voice input from a user of a device;
determining that the voice input satisfies at least one criterion associated with a first configuration of virtual objects on a display of the device; and
in response to the voice input satisfying the at least one criterion, changing the first configuration of the virtual objects to a second configuration of the virtual objects.

10. The system of claim 9, wherein changing the first configuration of the virtual objects to the second configuration of the virtual objects comprises moving a first window for the virtual objects from a first location on the display to a second location on the display.

11. The system of claim 9, wherein changing the first configuration of the virtual objects to the second configuration of the virtual objects comprises changing a first virtual object of the virtual objects from a first size to a second size.

12. The system of claim 9, wherein the method further comprises:
determining a gaze associated with the user,
wherein changing the first configuration of the virtual objects to the second configuration of the virtual objects comprises changing the first configuration of the virtual objects to the second configuration of the virtual objects based on the gaze.

13. The system of claim 9, wherein the first configuration comprises a first virtual object of the virtual objects overlaid on a second virtual object of the virtual objects, and wherein the second configuration comprises the first virtual object not overlaid on the second virtual object.

14. The system of claim 9, wherein the first configuration comprises a first virtual object of the virtual objects overlaid on a second virtual object of the virtual objects, and wherein the second configuration comprises an arrangement of the first virtual object relative to the second virtual object based on a preference of the user.

15. The system of claim 9, wherein the method further comprises:
identifying at least one virtual object of the virtual objects on the display of the device; and
obtaining the second configuration from a model configured to provide the second configuration based on the at least one virtual object.

16. A computer-readable storage medium storing executable instructions that, when executed by at least one processor, cause the at least one processor to execute a method, the method comprising:
receiving voice input from a user of a device;
determining that the voice input satisfies at least one criterion associated with a first configuration of virtual objects on a display of the device; and
in response to the voice input satisfying the at least one criterion, changing the first configuration of the virtual objects to a second configuration of the virtual objects.

17. The computer-readable storage medium of claim 16, wherein changing the first configuration of the virtual objects to the second configuration of the virtual objects comprises
moving a first window for the virtual objects from a first location on the display to a second location on the display.

18. The computer-readable storage medium of claim 16, wherein changing the first configuration of the virtual objects to the second configuration of the virtual objects comprises
changing a first window for the virtual objects from a first size to a second size.

19. The computer-readable storage medium of claim 16, wherein the method further comprises:
determining a gaze associated with the user,
wherein changing the first configuration of the virtual objects to the second configuration of the virtual objects comprises changing the first configuration of the virtual objects to the second configuration of the virtual objects based on the gaze.

20. The computer-readable storage medium of claim 16, wherein the method further comprises:
identifying at least one virtual object of the virtual objects on the display of the device; and
obtaining the second configuration from a model configured to provide the second configuration based on the at least one virtual object.
